(19) United States
(12) Patent Application Publication
(10) Pub. No.: US 2012/0199803 A1
(43) Pub. Date: Aug. 9, 2012

(54) SWING GATE

(75) Inventor: Edward Evans, Inverell (AU)

(73) Assignee: Safergate Group Pty Ltd., Brisbane, Queensland (AU)

(21) Appl. No.: 13/503,021

(22) PCT Filed: Oct. 11, 2010
(86) PCT No.: PCT/AU2010/001332

§ 371 Date: Apr. 19, 2012

(30) Foreign Application Priority Data
Oct. 20, 2009 (AU) 2009101060

(51) Int. Cl. E06B 11/04; A01K 3/00

(52) U.S. Cl. 256/73

(57) ABSTRACT

A swing gate (30) enables safe locking and unlocking of the gate (30) in the face of a beast (24) captured between rails (36, 38). The gate (30) has a pivot end (32) connected to the rail (36) by hinges (40) and a distal end (34) remote from the pivot end (32). The gate (30) includes a centre hinge (42) between the pivot end (32) and the distal end (34). The centre hinge (42) effectively divides the gate (30) into two sections, namely, a primary section (44) between the pivot end (32) and the centre hinge (42) and a safety section (46) between the centre hinge (42) and the distal end (34). When the beast (24) attacks the gate (30), the primary section (44) can swing open while the safety section (46) folds away to protect an operator (22).

### FIELD OF THE INVENTION

The invention relates to a swing gate. In particular, the invention relates to a swing gate for use with cattle to prevent injury to an operator if a beast attacks or hits the gate.

### BACKGROUND TO THE INVENTION

Swing gates are used in cattle pens, yards and races as a barrier to direct cattle and to open and close the pens, yards and races. Swing gates are generally opened or closed by an operator standing on a side of the gate that is opposite the cattle. It often happens that while opening or closing a gate, a beast becomes agitated and may attack or hit the gate. If the gate is not locked and the operator is unable to get out of the way in time, the force of the beast hitting the gate can be transferred to the operator by the gate. As cattle can be very heavy and powerful, being struck by a gate in such a manner may result in severe injury to the operator. Further, having to concentrate on a locking mechanism of the gate while staying aware of what a nearby beast is doing makes the operator's job even more difficult and hazardous. Thus the task of locking and unlocking gates is generally left to experienced operators due to the high risk of injury.

There is therefore a need for a swing gate that is safer for an operator to open, close, lock and unlock in the presence of cattle on the other side of the gate.

### OBJECT OF THE INVENTION

It is an object of the invention to overcome or at least alleviate one or more of the above problems and/or provide the consumer with a useful or commercial choice.

### SUMMARY OF THE INVENTION

In one form, although it need not be the only or indeed the broadest form, the invention resides in a swing gate, comprising:

a primary section having a pivot end about which the swing gate is pivotable;

a safety section having a distal end remote from the pivot end; and

a centre hinge between the primary section and the safety section, wherein the safety section is hingedly displaceable relative to the primary section.

Preferably, a screen is fixed to a side of the safety section of the swing gate.

Preferably, the screen includes a number of holes formed therein.

Preferably, the primary section comprises two end posts and a plurality of cross bars.

Preferably, the safety section comprises two end posts and a plurality of cross bars.

Preferably, the primary section is wider than the safety section.

Preferably, the distal end of the safety section is lockable to a fixed rail.

Preferably, the screen comprises corrugated steel.

Preferably, the centre hinge comprises sleeves that capture parts of an end post of the primary section.

### BRIEF DESCRIPTION OF THE DRAWINGS

To assist in understanding the invention and to enable a person skilled in the art to put the invention into practical effect, preferred embodiments of the invention will be described by way of example only with reference to the accompanying drawings, wherein:

FIG. 1 shows a diagrammatic top view of a prior art swing gate located between two rails, and an operator busy locking the gate in a closed position of the gate;

FIG. 2 shows a diagrammatic top view of the prior art swing gate of FIG. 1, showing a beast hitting the gate before the operator managed to lock the gate;

FIG. 3 shows a diagrammatic perspective view of a swing gate in accordance with one embodiment of the invention;

FIG. 4 shows a diagrammatic front view of the swing gate of FIG. 3;

FIG. 5 shows a diagrammatic top view of the swing gate of FIG. 3 and an operator busy locking the gate in a closed position of the gate;

FIG. 6 shows a diagrammatic top view of the swing gate of FIG. 3, showing a beast hitting the gate before the operator managed to lock the gate and how a safety section of the gate folds away as the gate hits the operator; and

FIG. 7 shows a diagrammatic front view of another embodiment swing gate in accordance with the invention.

### DETAILED DESCRIPTION OF THE INVENTION

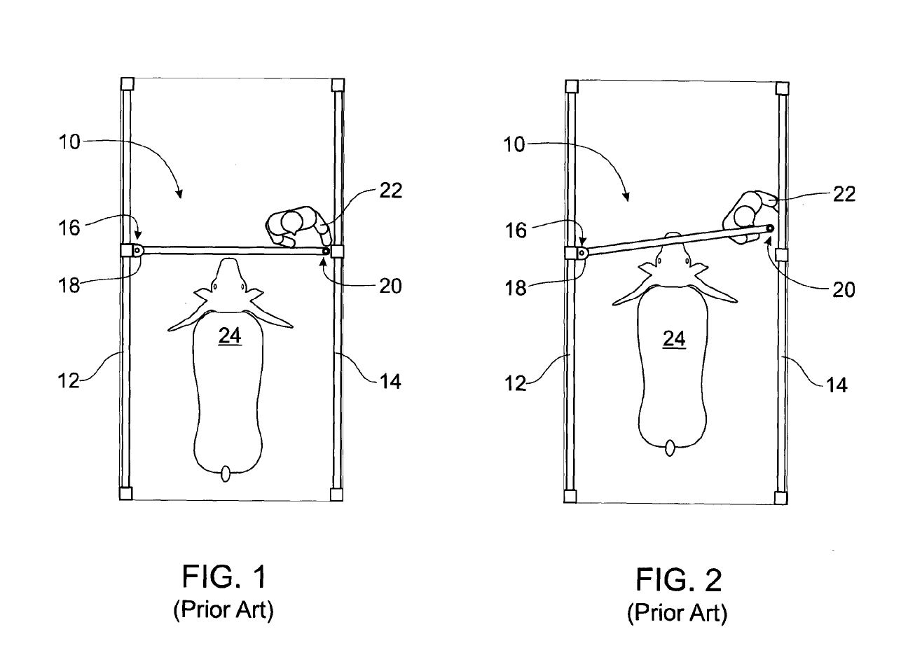

With reference to FIG. 1, a top view of a prior art swing gate 10 is shown. The swing gate 10 extends between two rails 12, 14. A pivot end 16 of the gate 10 is pivotally connected to the rail 12 at a hinge 18. A distal end 20 of the gate 10 moves between open positions and a closed position as the gate 10 pivots when opening and closing the gate 10. FIG. 1 shows the closed position of the gate 10, wherein the gate 10 is perpendicular relative to the rails 12, 14. An operator 22 locks the gate 10 in the closed position by looping a chain between the distal end 20 of the gate 10 and the rail 14 and locking the chain. However, it is not uncommon for a beast 24 trapped between the rails 12, 14 to attack the gate 10 as the operator 22 locks the gate 10.

Referring to FIG. 2, the beast 24 is shown ramming the gate 10 such that the operator 22 is hit by an end region of the gate 10 when the distal end 20 of the gate 10 is forced open by the beast 24. The beast 24, being heavy and strong, may transfer enough force onto the gate 10 to injure the operator 22.

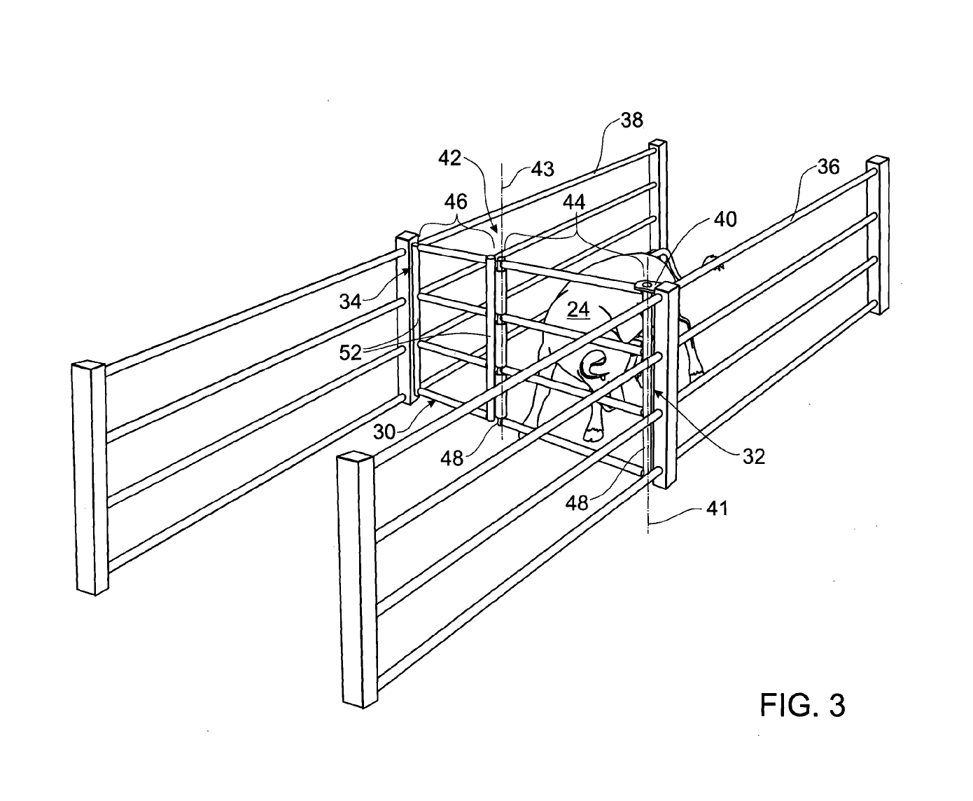

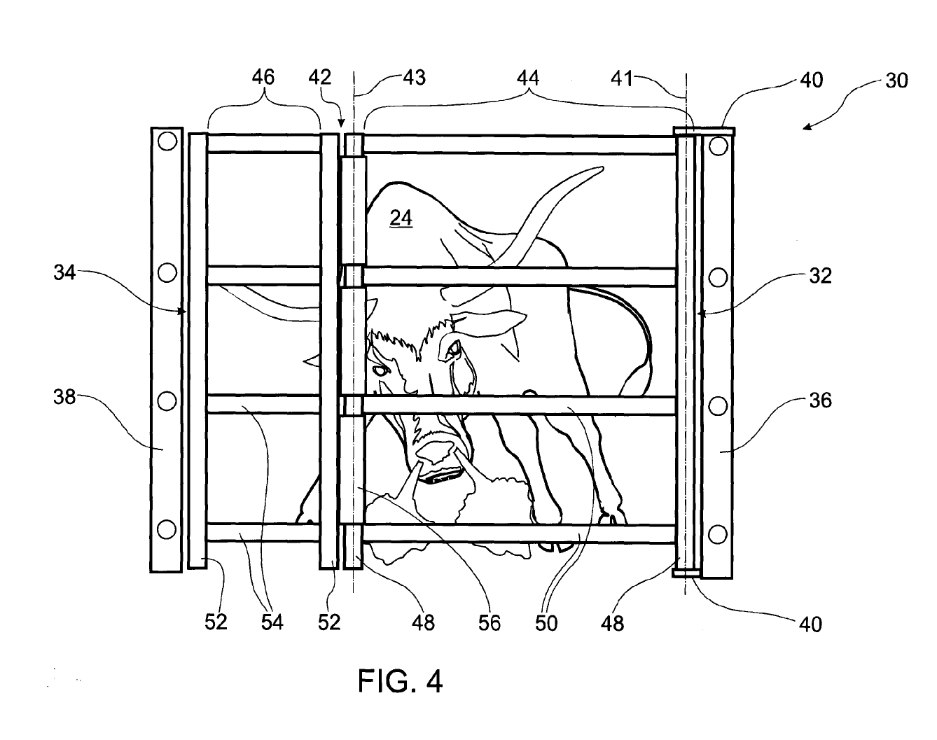

FIGS. 3 and 4 show one embodiment of a swing gate 30 in accordance with the present invention. The gate 30 can make it safer for an operator to open and close the gate 30 when a beast 24 is located nearby on an opposite side of the gate 30. The gate 30 has a pivot end 32 about which the gate 30 is pivotable and a distal end 34 remote from the pivot end 32. The gate 30 extends between two fixed rails 36, 38. The pivot end 32 is pivotally connected to the rail 36 by hinges 40 at the top and bottom of the rail 36. The gate 30 includes a centre hinge 42 between the pivot end 32 and the distal end 34. The centre hinge 42 effectively divides the gate into two sections, namely, a primary section 44 between the pivot end 32 and the centre hinge 42, and a safety section 46 between the centre hinge 42 and the distal end 34.

The primary section 44 comprises a frame of two spaced end posts 48 and cross bars 50 extending between the end posts 48. One of the end posts 48 at the pivot end 32 of the gate 10 is held between the hinges 40. The hinges 40 define a swing axis 41 between them about which the primary section 44 is pivotable between open positions and a closed position. FIGS. 3, 4 and 5 show the primary section 44 in the closed position.

The safety section 46 comprises two spaced end posts 52 and cross bars 54 extending between the end posts 52. The safety section 46 is hingedly connected to the primary section 44 by the centre hinge 42.

The centre hinge 42 comprises sleeves 56 which capture parts of the end post 48 of the primary section 44 and is welded to one of the end post 52 of the safety section 46 that is adjacent the centre hinge 42. The sleeves 56 define a vertical flap axis 43 between them about which the safety section 46 is pivotable.

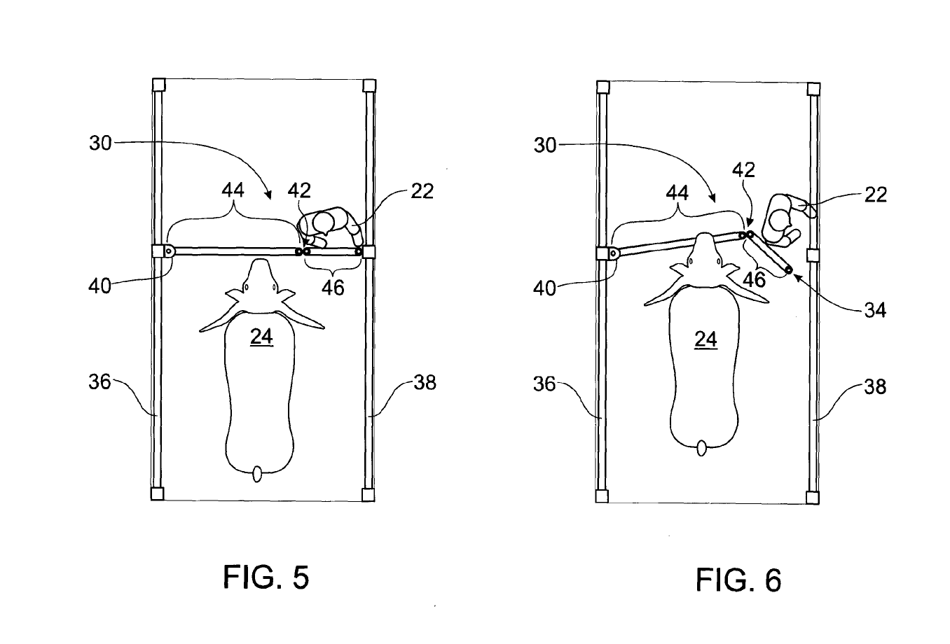

The primary section 44 can thus swing between open and closed positions about the swing axis 41 and the safety section 46 can swing into and out of parallel alignment with the primary section 44 as is described in more detail with reference to FIGS. 5 and 6. As illustrated, the primary section 44 can be significantly wider than the safety section 46.

FIG. 5 shows a top view of the swing gate 30 being closed and locked by an operator 22 in front of a beast 24. The operator 22 locks the gate 30 in a closed position by looping a chain between the post 52 at the distal end 34 of the gate 30 and the rail 38. In doing so he locates himself on an opposite side of the gate 30 away from the beast 24. In the closed position of the gate 30, the primary section 44 of the gate 30 is perpendicular to the rails 36, 38 and the safety section 46 is aligned parallel with the primary section 44.

Referring to FIG. 6, a top view of the swing gate 30 shows the beast 24 ramming the gate 30 before the gate 30 has been locked. When the beast 24 rams the un-locked gate 30, the primary section 44 swings open. The safety section 46 hits the operator 22; however, because the safety section 46 is hingedly connected to the primary section 44, the safety section 46 swings out of alignment with the primary section 44. The safety section 46 thus folds away from the operator 22 as the beast 24 presses against the primary section 44. The operator 22 is thus free to pass through a gap created between the primary section 44 and the rail 38 as the safety section 46 folds away when the beast 24 forces the primary section 44 to the open position. The only transfer of force onto the operator 22 is that necessary to have the safety section 46 swing out of alignment with the primary section 44, thus providing significant protection for the operator 22. The above description with reference to closing the gate 30 is similarly applicable to opening the gate 30.

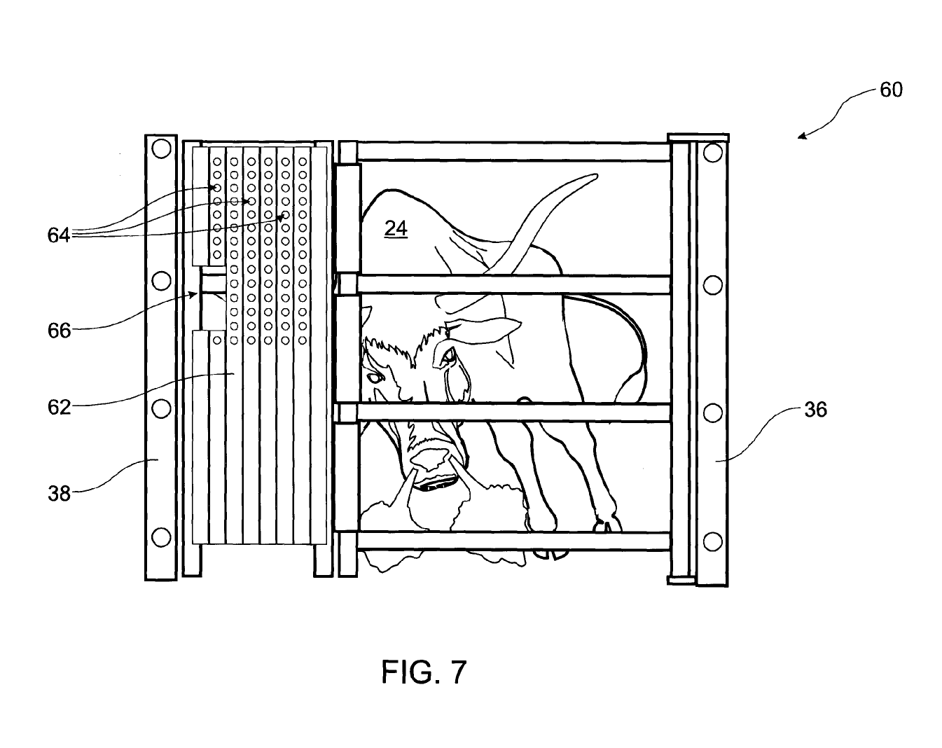

FIG. 7 is a front view of a swing gate 60 in accordance with another embodiment of the invention. The gate 60 is similar to the gate 30, with the only difference being a screen 62 placed over a safety section of the gate 60. The screen 62 may be fabricated from any suitable material, such as corrugated steel. The screen 62 has a grid of peep holes 64 located at about eyelevel. For example, the screen 62 can comprise a sheet of metal welded to the frame of the gate 60. The screen 62 hides the operator 22 from view of the beast 24 while the operator 22 locks the gate 60. The operator 22 is still able to view the beast 24 through the peep holes 64. The beast 24 will generally become more agitated when seeing the operator 22, so hiding the operator 22 from sight lessens the chance of the beast 24 attacking the gate 60. The screen 62 has a cut-out 66 through which the chain locking the gate 60 to the rail 38 can be passed.

When compared to the prior art gate 10, the gates 30 and 60 of the present invention are thus significantly safer for an operator 22 when the gates 30 and 60 are being locked and unlocked.

The above description of various embodiments of the present invention is provided for purposes of description to one of ordinary skill in the related art. It is not intended to be exhaustive or to limit the invention to a single disclosed embodiment. Numerous alternatives and variations to the present invention will be apparent to those skilled in the art of the above teaching. Accordingly, while some alternative embodiments have been discussed specifically, other embodiments will be apparent or relatively easily developed by those of ordinary skill in the art. Accordingly, this invention is intended to embrace all alternatives, modifications and variations of the present invention that have been discussed herein, and other embodiments that fall within the spirit and scope of the above described invention.

1. A swing gate, comprising:
a primary section having a pivot end about which the swing gate is pivotable;
a safety section having a distal end remote from the pivot end; and
a centre hinge between the primary section and the safety section, wherein the safety section is hingedly displaceable relative to the primary section, rotation of the safety section relative to the primary section about the centre hinge rotates all sections of the gate that are on a same side of the centre hinge as the safety section, and the centre hinge enables the safety section to rotate in either direction away from a plane of the primary section.

2. The swing gate of claim 1, wherein a screen is fixed to a side of the safety section of the swing gate.

3. The swing gate of claim 2, wherein the screen includes a number of holes formed therein.

4. The swing gate of claim 1, wherein the primary section comprises two end posts and a plurality of cross bars.

5. The swing gate of claim 1, wherein the safety section comprises two end posts and a plurality of cross bars.

6. The swing gate of claim 1, wherein the primary section is wider than the safety section.

7. The swing gate of claim 1, wherein the distal end of the safety section is lockable to a fixed rail.

8. The swing gate of claim 1, wherein the screen comprises corrugated steel.

9. The swing gate of claim 1, wherein the centre hinge comprises sleeves that capture parts of an end post of the primary section.
